(19) United States
(12) Patent Application Publication
(10) Pub. No.: US 2009/0296144 A1
(43) Pub. Date: Dec. 3, 2009

(54) JOB PROCESSING METHOD, IMAGE PROCESSING SYSTEM AND IMAGE PROCESSING APPARATUS

(75) Inventor: Nobuaki Fukasawa, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/469,046

(22) Filed: May 20, 2009

(30) Foreign Application Priority Data
Jun. 3, 2008 (JP) 2008-146220

(51) Int. Cl. G06F 15/00

(52) U.S. Cl. 358/1.15

(57) ABSTRACT

In an image processing method for performing image processing by causing a plurality of image processing apparatuses including a first image processing apparatus and a second image processing apparatus to work in cooperation, an image processing apparatus that issues a job sends an announcement notice informing that the job will be sent to image processing apparatuses designated to perform image processing in cooperation. When excluding the first image processing apparatus designated as a cooperative device from cooperation, an instruction to abort transition of the job is sent to the first image processing apparatus based on the announcement notice. Alternatively, an instruction to abort transition of the job is sent to the second image processing apparatus that transitions the job to the first image processing apparatus.

### BACKGROUND OF THE INVENTION

1. Field of the Invention

The present invention relates to a technique with which a plurality of image processing apparatuses executes a job in cooperation with each other.

2. Description of the Related Art

An image processing system is conventionally known in which a plurality of image processing apparatuses connected with a network performs a process in cooperation with each other.

In such a system, if a problem or the like occurs in an image processing apparatus as a transfer destination that has once received a job, it is necessary to accurately figure out the problem and solve it.

Japanese Patent Laid-Open No. 2000-231470 discloses this type of technique in which when a problem occurs in an apparatus that is a transfer destination, the transfer source automatically searches again for a transfer destination and changes the transfer destination.

### SUMMARY OF THE INVENTION

According to the above conventional technique, however, it is not possible to check or change job status from an image processing apparatus that is a transfer destination.

For example, it is not possible for an image processing apparatus as a transfer destination to accept changes to the content of a job.

The present invention has been conceived to solve such problems encountered with conventional techniques, and the present invention provides to make it possible to change the content of a job from an image processing apparatus designated to process the job in cooperation, and thereby providing a user-friendly image-processing system.

According to one aspect of the present invention, there is provided a job processing method for executing a job by causing a plurality of image processing apparatuses to work in cooperation with each other, the method comprising: sending an announcement notice informing that the job will be sent from an image processing apparatus that issues a job to an image processing apparatus designated to process the job in cooperation; and instructing the image processing apparatus that issued the job or the image processing apparatus designated to work in cooperation to abort transition of the job based on the announcement notice when excluding the image processing apparatus designated to work in cooperation from cooperation.

According to the present invention, it is possible to provide a user-friendly image-processing system in which the content of a job can be changed from any of the image processing apparatuses designated to process the job in cooperation.

Further features of the present invention will become apparent from the following description of exemplary embodiments with reference to the attached drawings.

### BRIEF DESCRIPTION OF THE DRAWINGS

FIG. 1 is a diagram illustrating a configuration of an image processing system according to Embodiment 1 of the present invention.

FIG. 2 is a diagram illustrating an internal configuration of a PC that can be used in the image processing system according to Embodiment 1 of the present invention.

FIG. 3 is a diagram illustrating an internal configuration of an image processing apparatus that can be used in the image processing system according to Embodiment 1 of the present invention.

FIG. 4 is a diagram illustrating an example of a cooperative job-executing process.

FIG. 5 is a diagram illustrating an example of a cooperative job-executing process.

FIG. 6 is a diagram illustrating an example of a cooperative job-executing process.

FIG. 7 is a diagram illustrating an example of a cooperative job-executing process.

FIG. 8 is a sequence diagram illustrating the operations of devices in the image processing system according to Embodiment 1 of the present invention.

FIG. 9 is a sequence diagram illustrating the operations of devices in the image processing system according to Embodiment 1 of the present invention.

FIG. 10 is a flowchart illustrating a process flow performed by an image processing apparatus according to Embodiment 1 of the present invention.

FIG. 11 is a diagram illustrating an example of an announcement notice.

FIG. 12 is a diagram illustrating an example of an announcement notice.

FIG. 13 is a diagram illustrating an example of a job status change request.

FIG. 14 is a diagram illustrating an example of a job status change response.

FIG. 15 is a diagram illustrating an example of a job status change request.

FIG. 16 is a diagram illustrating an example of a job status change response.

### DESCRIPTION OF THE EMBODIMENTS

Hereinafter, an embodiment of the present invention will be described in detail with reference to the accompanying drawings. It should be understood, however, that the constituent elements described in the following embodiment are merely exemplary and, therefore, the scope of the present invention is not limited thereto.

Overview

In an image processing system according to an embodiment of the present invention, a plurality of image processing apparatuses (devices) perform the image processing of a single job in cooperation with each other using a network or another communication means.

Specifically, the image processing system of the present embodiment performs the following process as a process for obtaining job status information.

(1) A device involved in cooperation and operated by a user (hereinafter referred to as an “operation input device”) acquires the status information of a cooperative job, and displays information as to which device is currently processing the job.

(2) The user operates the operation input device to select a device to be excluded from cooperation (hereinafter referred to as a “replaced device”) and a device to be instead brought into cooperation (hereinafter referred to as a “replacing device”), and then provides an instruction to change the cooperative device.

(3) Upon receiving the input of an instruction to change the cooperating device, the operation input device issues a cooperation transition abort request to a relevant device based on an announcement notice, and the device that has received the request aborts the transition of the job to the next cooperative device.

(4) After a device to be eliminated from the processing of the cooperative job and a device to be incorporated into the cooperative process have been specified by the operation input device, a new announcement notice regarding the cooperative job is created, and then sent to all of the devices involved in the cooperative job. The devices that have received the new announcement notice regarding the cooperative job revise the previously received announcement notice.

(5) After that, the operation input device requests that the device that aborted the transition restart the transition. The device that has received the request to restart the transition of the aborted cooperative job restarts the transition of the cooperative job.

Through the above process, even when the devices are processing a job in cooperation with each other, it becomes possible to change the cooperative devices from any of the devices involved in such cooperation.

### Embodiment 1

### Specific Configuration

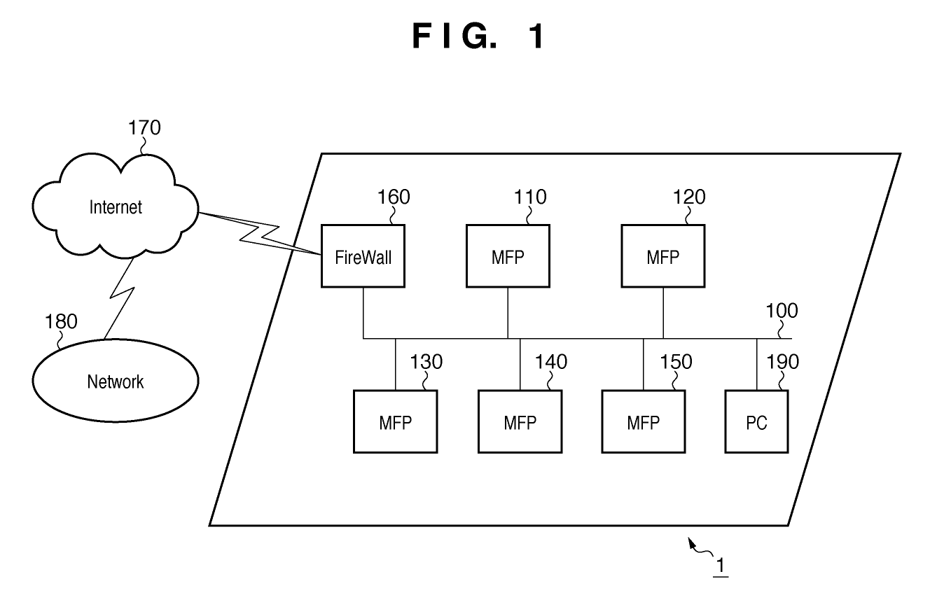

FIG. 1 is a schematic diagram illustrating the configuration of an image processing system 1 according to an embodiment of the present invention. In the image processing system 1, MFPs (multifunction peripherals) 110 to 150 as image processing apparatuses (devices) are connected. And in this system, a process requested by a user is executed on image data that is read from an original image by a scanner function of one of the MFPs, by other MFPs connected with the network.

In FIG. 1, the image processing system 1 includes MFPs 110 to 150 and a PC 190, and they are connected to the LAN 100. A firewall 160 manages communication between the LAN 100 and the Internet 170. The LAN 100 is further connected to another network 180 via the firewall 160 and the Internet 170.

The PC 190 can create print jobs based on instructions from the user, and transfer the print jobs to the MFPs 110, 120 and 130. A MFP that has received a transferred print job can process the print job. For example, image data read from an original image by a scanner unit of the MFP 110 can be processed by the MFP 120 (for example, prescribed data stored in the MFP 120 is added by the MFP 120), and printed by a printer unit of the MFP 130. When cooperative processing is necessary, one MFP or more is selected, a print job (hereinafter, a job processed through the cooperation of a plurality of apparatuses is referred to as a “cooperative job”) is created, and the cooperative job is transferred to an MFP that first processes the job. The MFP that has received the cooperative job processes the job, and transfers the cooperative job to the next instructed MFP. After that, in the case of cooperative jobs, this process is repeated until the MFP that produces a final output.

A configuration is also possible in which the user selects at least one MFP from among the MFPs connected with a network using a MFP, creates a cooperative job, and transfers the cooperative job to an MFP that first processes the job. The MFP that has received the cooperative job processes the job, and transfers the cooperative job to the next instructed MFP. After that, in the case of cooperative jobs, this process is repeated until the MFP that produces a final output.

According to the present invention, it is possible to check the status of a job or perform operations on a job from any device from among the PC 190 that issues jobs and the MFPs 110 to 150 that process cooperative jobs.

For example, a situation can occur in which the user has to wait for the MFP 130 to produce output when the MFP 120 is processing a cooperative job that is to be generated by the MFP 120, processed by the MFP 110 and finally outputted by the MFP 130. With the present invention, it becomes possible to change the cooperative devices that execute the cooperative job even from the MFP 130 that has not yet received the cooperative job.

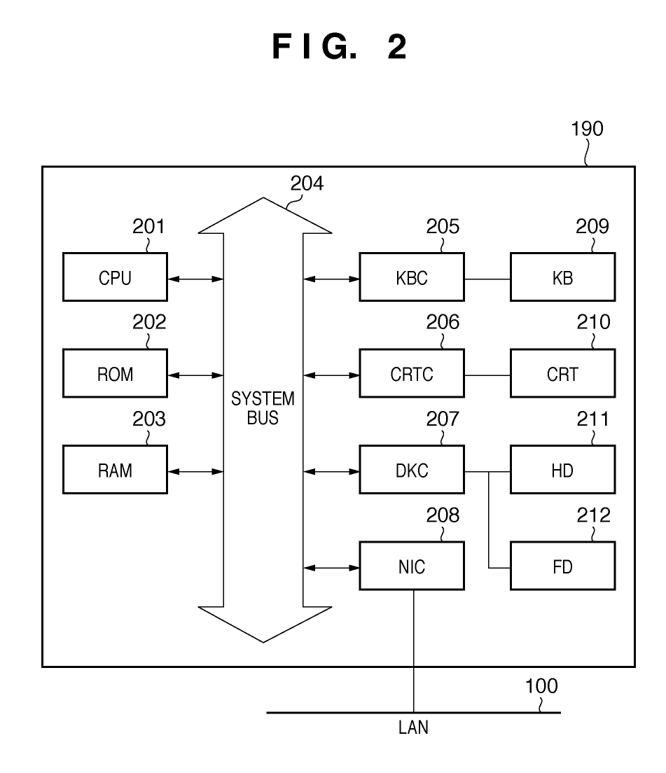

An internal configuration of the PC 190 of the image processing system will be described with reference to FIG. 2.

The PC 190 includes, as shown in FIG. 2, a CPU 201, a ROM 202, a RAM 203, and a system bus 204. The PC 190 also includes a keyboard controller (KBC) 205, a CRT controller (CRTC) 206, a disk controller (DKC) 207, and a network interface card (NIC) 208. The PC 190 further includes a keyboard (KB) 209, a CRT 210, a hard disk (HD) 211, and a flexible disk (FD) 212.

The CPU 201 executes various programs stored in the ROM 202 or the HD 211, or various programs supplied from the FD 212. The CPU 201 collectively controls the constituent elements connected to the system bus 204. The RAM 203 functions as a primary memory or working area for the CPU 201.

The KBC 205 controls the input of instructions from the KB 209, a pointing MFP (not shown) and so on. The CRTC 206 controls the display of the CRT 210.

The DKC 207 controls access to the HD 211 and the FD 212 serving as storage areas that implement a function for storing a boot program, a program for operating (controlling) the MFPs, and various applications. The HD 211 and the FD 212 also implement a box function for storing image data and a user file. The NIC 208 enables the transmission and reception (two-way communication) of data (image data, etc.) to and from devices (including other network devices) connected to the LAN 100 via the LAN 100.

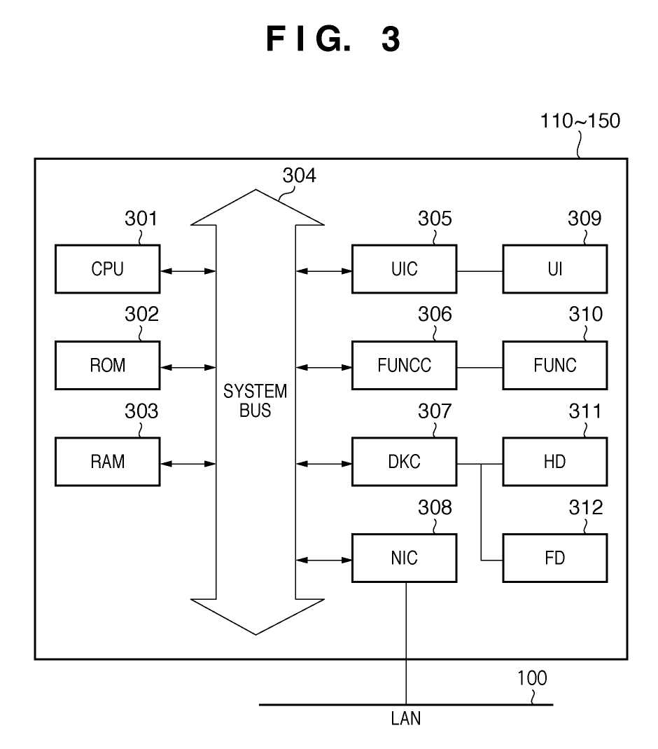

An internal configuration of the MFP 110 to 150 will be described with reference to FIG. 3. The MFP 110 to 150 is equipped with a CPU 301 that executes various programs that are stored in a ROM 302 or a hard disk (HD) 311 or supplied from a floppy® disk drive (FD) 312. The CPU 301 also collectively controls the devices connected to a system bus 304. A RAM 303 functions as a primary memory or working area for the CPU 301. A user interface controller (UIC) 305 controls the display of a user interface (UI) 309 and the input of instructions from the UI 309. A function controller (FUNCC) 306 implements and controls a function (FUNC) 310 unique to each MFP. The FUNC 310 of each MFP can have a different configuration. Examples of the configuration include a scanner unit that reads an original image and displays the image, a printer unit that prints an image based on input image data onto recording paper, etc. MFPs with a monochrome printer have a monochrome print engine controller and a monochrome print engine. MFPs with a color printer have a color print engine controller and a color print engine. Examples of the scanner unit include a color scanner that reads color images, and a monochrome scanner that reads monochrome documents. The configuration is not limited thereto, and it is possible to combine various functions such as a facsimile function and an image edit function as appropriate. The MFPs 110 to 150 each have a function controller (FUNCC) 306 and a function (FUNC) 310 for providing a function described above. The DKC 307 has a function for storing a boot program, a program for operating (controlling) the MFP, a program for working in cooperation with other apparatuses, and various applications. The DKC 307 also controls the HD 311 and the FD 312 serving as storage areas for implementing a box function for storing image data. A network interface card (NIC) 308 bidirectionally exchanges data with another MFP, a network printer or another PC connected to the LAN 100.

### STATE EXAMPLES

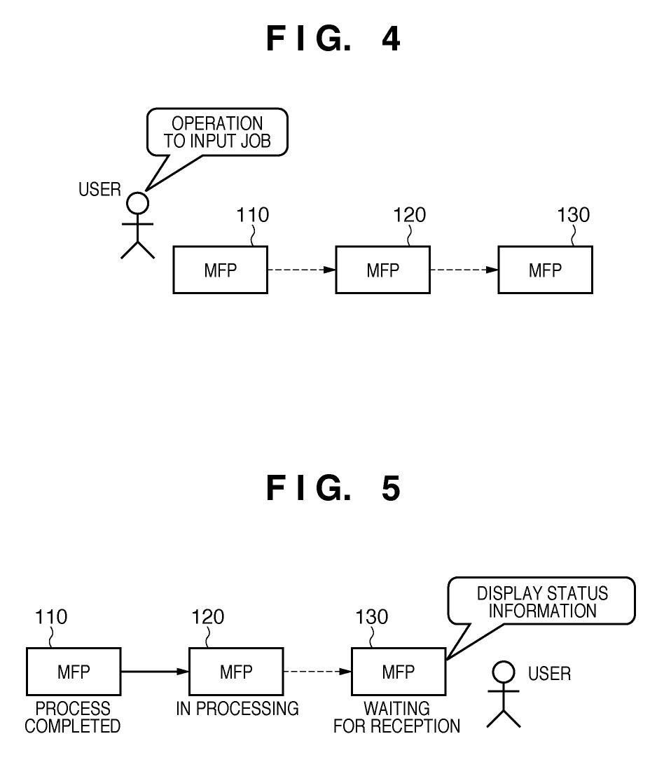

FIG. 4 shows an example of a job flow when three MFPs 110 to 130 of the image processing system 1 are used cooperatively. First, the user operates the MFP 110 to cause the MFP 110 to create a cooperative job and start the process. The MFPs 120 and 130 have been selected as cooperative MFPs, and the process is performed in this order. For example, image data read from an original image by the scanner unit of the MFP 110 is processed by the MFP 120 (for example, prescribed data stored in the MFP 120 is added by the MFP 120), and printed by the printer unit of the MFP 130.

FIG. 5 shows a state in which the user is waiting for processing by the MFP 130 that produces a final output after the state shown in FIG. 4. In FIG. 5, a cooperative job is to be processed in this order: MFP 110, MFP 120, and MFP 130. Here, the MFP 110 has finished processing the job, the MFP 120 is currently processing the job, and the MFP 130 is waiting for reception of the cooperative job. While the user is waiting for processing by the MFP 130, he/she can operate the UI 309 of the MFP 130 to change an apparatus as a cooperative partner of the image processing system.

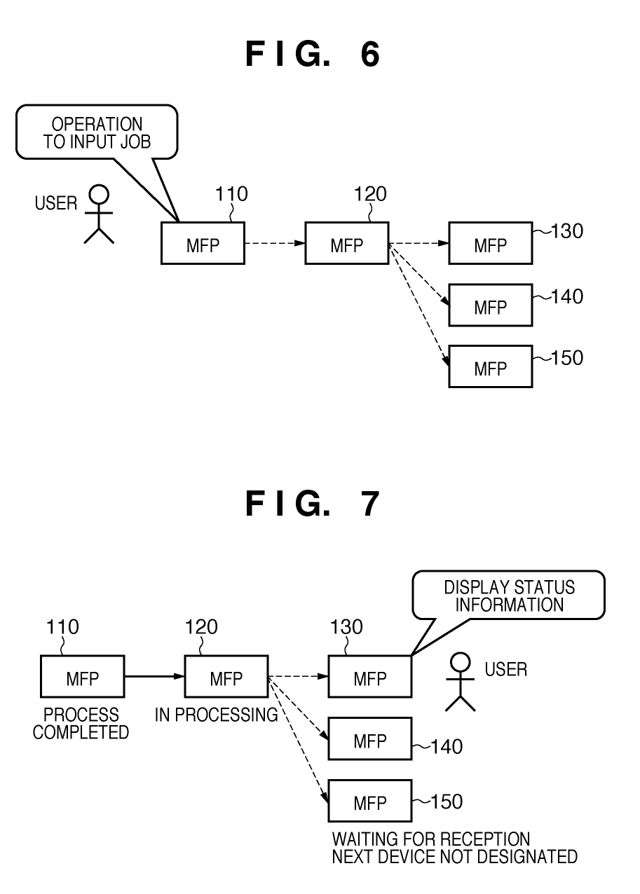

FIG. 6 shows a state in which in the image processing system 1, not all cooperative MFPs have been designated (determined) when a cooperative job is input. The user operates the MFP 110 to cause the MFP 110 to create a cooperative job and start the process. At this time, the MFP 120 has been designated as the second cooperative MFP, but the third cooperative MFP is not determined yet, and simply the MFPs 130, 140 and 150 are listed as candidates. That is, to which one of the MFPs the job is to be transferred to has not been determined. If the third cooperative MFP is determined when the MFP 120 finishes processing the job, the job will be transferred to the determined cooperative MFP. The third cooperative MFP can be, for example, one of the MFPs 130, 140 and 150 that can finish processing first when the MFP 120 becomes ready to transfer the job (image data) after it finishes processing.

FIG. 7 shows a state in which the user is waiting for processing by one of the candidates for the cooperative MFP that produces a final output after the state of FIG. 6. In FIG. 7, it has been determined that a cooperative job is to be processed by the MFP 110 first and then by the MFP 120, and the MFP 110 has already finished processing, and the MFP 120 is currently processing the cooperative job. However, the third cooperative MFP has not yet been determined from among the candidates: MFPs 130, 140 and 150. In the system of the present embodiment, the user who is waiting for processing by the MFP 130, that is, an MFP selected from among the candidate MFPs, can operate the MFP 130 to change an apparatus as a cooperative partner.

Specific Process Flow

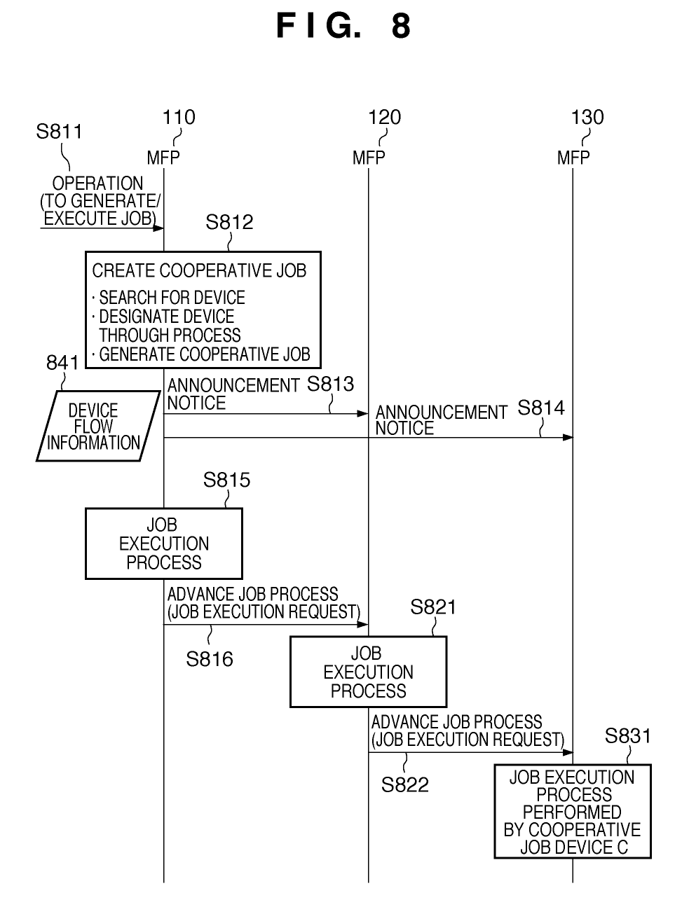

FIG. 8 shows a communication sequence among the MFPs in the state of FIG. 4. The user operates the MFP 110 to input a cooperative job (S811). At this time, the MFP 110 searches for MFPs that can execute the cooperative job from among the MFPs with which it can communicate, determines MFPs that will process the cooperative job in cooperation, and generates a cooperative job (S812).

Next, the MFP 110 creates device flow information 841, and sends, to the MFPs 120 and 130, an announcement notice informing that the cooperative job will be sent, together with the device flow information 841 (S813, S814). This announcement notice includes information indicating that the cooperative job will be transferred, information for identifying each cooperative MFP (apparatus name, etc.), a job ID for identifying the cooperative job, etc. Through this, each MFP manages the job data, the job status and so on with the common job ID.

Next, the MFP 110 executes its assigned task of the job (S815). After S815, the MFP 110 sends a job execution request to the MFP 120 in order to advance the process of the cooperative job (S816). This job execution request includes the job ID, etc. Upon receiving the job execution request, the MFP 120 executes its assigned task of the cooperative job corresponding to the announcement notice received previously. After it finishes processing, in the same manner as above, the MFP 120 sends a job execution request to the MFP 130 in order to advance the process of the cooperative job (S822). Upon receiving the job execution request, the MFP 130 executes its assigned task of the job (S831).

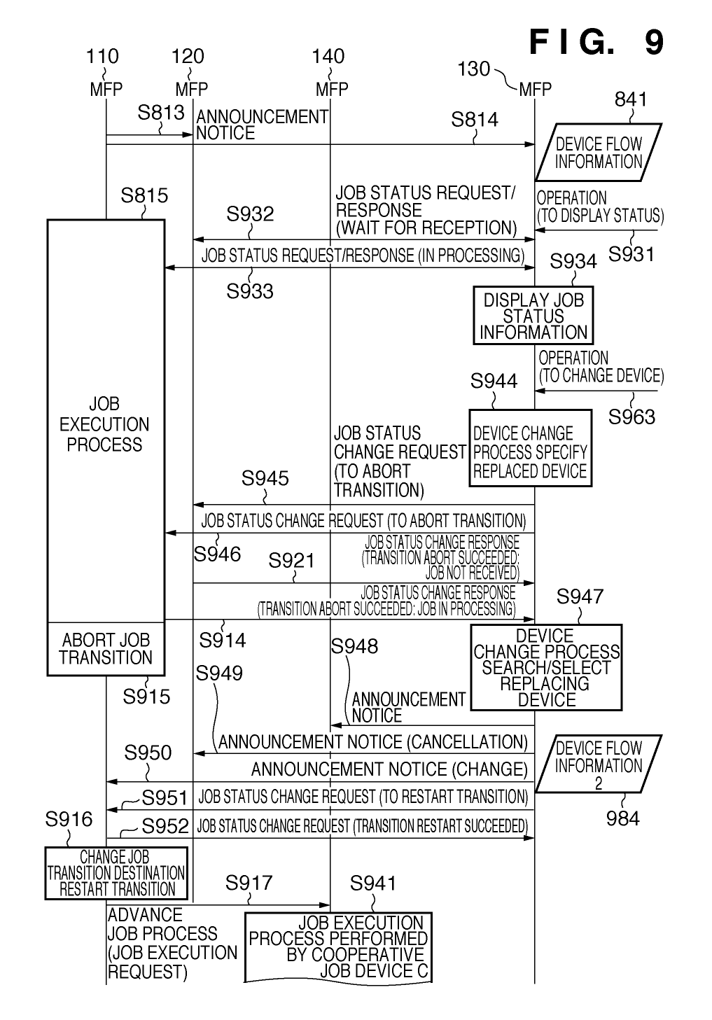

FIG. 9 shows a communication sequence among the MFPs in the state of FIG. 5. The processes up to S815 are the same as those of FIG. 8, and, as such, the same reference numerals are assigned to the same processes, and descriptions thereof are omitted here.

When the MFP 130 receives an operation request to display a job status from the user (S931), the MFP 130 requests the current status information of the cooperative job. Specifically, the MFP 130 sends a status information request message to the MFPs 110 and 120 based on the device flow information 841 obtained with the announcement notice message.

In S931, when the MFP 130 receives an operation to request status information from the user, the MFP 130 sends a status information request including the job ID included in the previous announcement notice to the MFPs 110 and 120 (S932, S933). Specifically, the MFP 130 operates the UI 309 to display a job list, and when a job is selected from that list, the corresponding flow information and job ID are read, and the status information request is sent. At this time, the MFP 130 designates the MFPs 110 and 120 as destinations of the status information request in accordance with the device flow information 841 obtained from the announcement notice.

In response to the status information request, the MFP 110 returns a status information response indicating that the MFP 110 is processing the job having that job ID (in processing) to the MFP 130 (S932). Likewise, in response to the status information request, the MFP 120 returns a status information response indicating that the MFP 120 is waiting for reception of the job having that job ID (reception wait) to the MFP 130 (S932).

Upon receiving the responses to the job status information request, the MFP 130 displays the job status information based on the responses (S934). If, for example, status information is requested to the MFP 130 through the user's operation of the UI 309, the status information is displayed on the UI 309, and if the MFP 130 is operated from the PC, the status information is displayed on a screen of the PC.

Subsequently, when the MFP 130 receives an instruction to change a device from the user (S963), it specifies an MFP to be changed (S944). The instruction to change a device includes an instruction to exclude an apparatus that was once designated as a cooperative partner from cooperation, and an instruction to change an apparatus that was designated as a cooperative partner to another apparatus. The following will be described in the context of receiving an instruction to change the cooperative apparatus from the MFP 120 to the MFP 140.

In S945 and S946, a job status change request (to abort transition) including the job ID is sent to the MFP 120 and to an apparatus, as a transition source, that performs the transition of the job to the MFP 120 (MFP 110 in this example) according to the instruction. Upon receiving the job status change request (to abort transition), the MFPs 110 and 120 return a response according to their status (S921, S914).

In this example, in S914, the MFP 110 sends, to the MFP 130, a message indicating that it has successfully received the request to abort transition, and that the current job status is that it is currently processing the cooperative job. In S921, the MFP 120 sends, to the MFP 130, a message indicating that the current job status is that it is currently waiting for reception of the cooperative job, and that it has successfully received the request to abort transition. The MFP 110 aborts a job execution request (to advance the job process) that would otherwise be sent to the MFP 120 (S915).

Upon receiving the messages in S914 and S921, the MFP 130 executes a device change process (S947), and the user searches for and selects a replacing device. It is assumed here that the user selects the MFP 140 as a post-change cooperative device (replacing device).

When the MFP 140 is selected as a replacing device, the MFP 130 operated by the user sends an announcement notice to the MFPs 110, 120 and 140 that are the relevant cooperative partners (S948, S949, S950). This announcement notice includes flow information 964 including information regarding the replacing device selected in S947. The announcement notice sent in S948 is for the MFP 140, and includes similar content to those sent in S813 and S814. The announcement notice sent in S949 is for the MFP 120, and indicates that the announcement notice sent in S813 has been canceled. The announcement notice sent to the MFP 110 in S950 indicates the changed transition destination device of the cooperative job.

After that, in S951, the MFP 130 sends a job status change request (to restart transition) to the MFP 110. Upon receiving the request to restart transition, the MFP 110 returns a job status change response (to restart transition) to the MFP 130, and restarts the transition process of the aborted cooperative job (S916). The transition destination of the job is the MFP 140 specified by the announcement notice sent in S950. That is, a job execution request is sent to the MFP 140 (S917). Upon receiving the job execution request, the MFP 140 starts processing the cooperative job (S941).

FIG. 10 is a flowchart illustrating the processes performed by each MFP. This flowchart shows a process flow executed by the CPU 301 reading a computer program stored in the ROM 302, the HD 311 or the like. When turned on, the MFP performs an initialization process S1001, and then waits for reception of a request from the UI 309 or an external device in S1002. If it is determined that the MFP has received a request to execute a job, the process advances to S1010 where the MFP starts a process for executing the job, and then the process returns to S1002 where the MFP waits again for reception of a request from the UI 309 or an external device. If the MFP receives a job generation request, the process advances to S1020, where the MFP starts a job generation process, and then the process returns to S1002 where the MFP waits again for reception of a request from the UI 309 or an external device. If the MFP receives a job status change request, the process advances to S1030 where the MFP starts a job status change request process, and then the process returns to S1002 where the MFP waits again for reception of a request from the UI 309 or an external device. If the MFP receives an MFP search/select process request, the process advances to S1040 where the MFP starts an MFP search and select process, and then the process returns to S1002 where the MFP waits again for reception of a request from the UI 309 or an external device. If the MFP receives an announcement notice, the process advances to S1050 where the MFP starts an announcement notice process, and then the process returns to S1002 where the MFP waits again for reception of a request from the UI 309 or an external device. If the MFP receives a job status display request, the process advances to S1060 where the MFP starts a job status display process, and then the process returns to S1002 where the MFP waits again for reception of a request from the UI 309 or an external device. If the MFP receives another request, the process advances to S1070 where the MFP starts a process according to the request, and then the process returns to S1002 where the MFP waits again for reception of a request from the UI 309 or an external device. If the MFP receives an exit request, the process advances to S1080 where the MFP starts an exit process, and then operation of the MFP ends.

The following describes how each of the MFPs described in FIGS. 8 and 9 performs processing in FIG. 10.

Upon receiving an instruction to generate and execute a job through the operation of the UI 309 or an external PC by the user, the MFP 110 of FIG. 8 first executes S1040 where it searches for apparatuses that can execute the job, and determines the apparatuses that will execute the job in cooperation. In the next step, S1020, the MFP 110 generates a cooperative job including a task assigned to each apparatus to be executed. Then, in S1050, the MFP 110 sends an announcement notice as described above to the apparatuses as cooperative partners. In S1010, the MFP 110 executes its assigned task of the job, and then sends image data as a result of executing the job and a job execution request to other cooperative MFPs. The MFPs 120 and 130 of FIG. 8 receive the announcement notice in S1050, receive the job execution request in S1010, and execute the cooperative job.

The MFP 110 of FIG. 9 performs the process of receiving a job status information request and sending a response to the request (S933) with the process started in S1060 of FIG. 10. Likewise, the process of receiving a job status change request (to abort transition) (S946), sending a response to the request (S914), and aborting job transition (S915) is performed with the process started in S1030 of FIG. 10. After that, the MFP 110 receives an announcement notice (S950), which is performed with the process started in S1050 of FIG. 10. Then, the MFP 110 receives a job status change request (to restart transition) (S951), performs a response process (S952), changes the job transition destination, restarts transition (S916), and sends a job execution request (S917), all of which are performed with the process started in S1030 of FIG. 10.

In S1060, the MFP 120 of FIG. 9 receives a job status information request, and returns a response to the request. When the MFP 120 receives a job status change request while it is executing a job, the MFP 120 returns a response to the request in S1030. After that, the MFP 120 receives an announcement notice (S949), which is performed with the process started in S1050 of FIG. 10.

The MFP 140 of FIG. 9 receives an announcement notice (S948), a job execution request (S917), and performs a cooperative job execution process (S941). These are exactly the same as those of the MFP 120 of FIG. 8 and, thus, their relationship to the processes of FIG. 10 is also the same.

As for the MFP 130 of FIG. 9, the processes up to S814 where an announcement notice is received are the same as those of the MFP 130 of FIG. 8. When an operation is performed by the user (through the UI 309 or the PC) to request a status be displayed, S1060 of FIG. 10 is carried out. Then, the processes for sending/receiving a job status information request/response (S931, S932) and displaying job status information (S934) are executed with the process started in S1060 of FIG. 10.

Next, an operation to change a device is performed by the user, and a replaced device is specified (S944) with the process started in S1060 of FIG. 10. Also, the transmission of a job status change request (S945, S946), and the reception of a job status change response (S921, S914) are executed with the process started in S1030 of FIG. 10.

Next, the MFP 130 performs a device search/select process (S947) to search for and select a device to be used as a replacing device, which is executed with the process started in S1040 of FIG. 10. Then, the transmission of an announcement notice (S948, S949, S950) is performed in S1050 of FIG. 10. The transmission of a job status change request (S951) and a response process (S952) is performed in S1030 of FIG. 10.

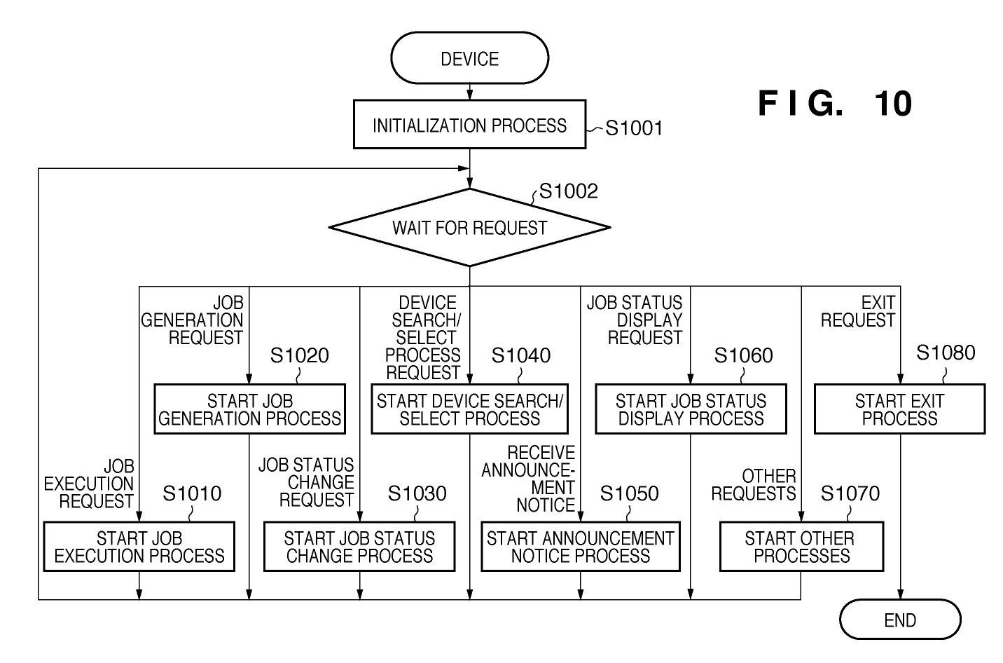

FIG. 11 is a diagram illustrating an example of information included in an announcement notice. A column 1110 shows the items of information included in the announcement notice, and a column 1120 shows the content of the information. A line 1130 indicates that the issuer who issued the job is “Ginji”. A line 1131 indicates that the job was issued at 16:19:08 on Jun. 7, 2007 (Japan time). A line 1132 indicates that the name of the job is 20070607161908. A line 1133 indicates that the job ID is A-1234. The subsequent lines 1140 to 1144 show the content of the device flow information 841 of FIG. 8. The line 1141 indicates that the MFP 110 is the first MFP that processes the cooperative job. Likewise, the lines 1142 to 1144 indicate that the second device has been changed from the MFP 120 to the MFP 140, and the MFP 130 is the third, respectively. The flow information shown here is flow information obtained when cooperative MFPs have been determined at the point in time when a job is inputted to the first MFP, as shown in FIG. 4.

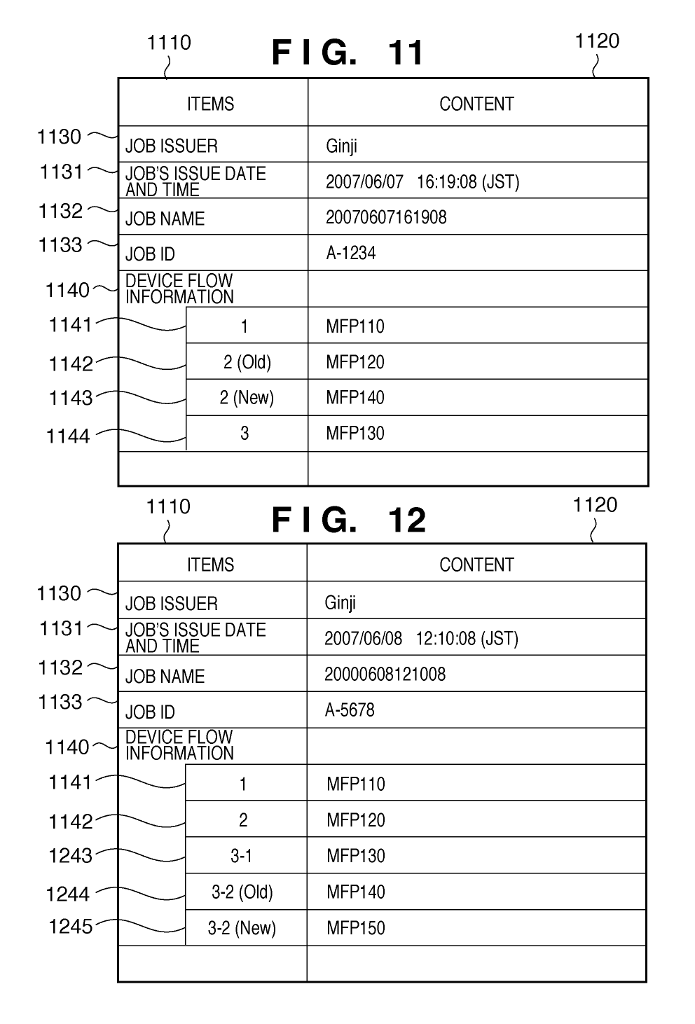

FIG. 12 is a diagram illustrating another example of an announcement notice. This is an announcement notice obtained when cooperative MFPs are not determined when a job is inputted, as shown in FIG. 6. In FIG. 12, columns 1110 and 1120, and lines 1130 to 1141 are the same as those of FIG. 11, so descriptions thereof are omitted here.

Lines 1243 to 1245 indicate that the third cooperative device had not been determined at the point in time when this announcement notice was created. It is also indicated that a candidate for the third device has been changed from the MFP 140 to the MFP 150. That is, it is indicated that the MFP 130 and the MFP 150 are the candidates for the third processing device.

It is to be understood that the announcement notice, the items of flow information, and the content of the flow information described above are merely exemplary and, thus, for example, IP address or the like can be used instead of apparatus name as information for identifying MFPs that is included in such flow information.

FIG. 13 shows an example of a job status change request sent in S945, S946 of FIG. 9 (information 1300). A column 1310 shows the items of information included in the job status change request, and a column 1320 shows the content of the information. A line 1321 shows the type of job status change request, and the content thereof indicates that the request is to abort transition. A line 1330 indicates that the issuer is “Ginji”. A line 1331 indicates that the issue date and time is 16:27:10 on Jun. 7, 2007 (Japan time). A line 1332 indicates that the job name is 20070607162710. A line 1333 indicates that the job ID is A-12345.

It is to be understood that the items of the job status change request and the content thereof are merely exemplary.

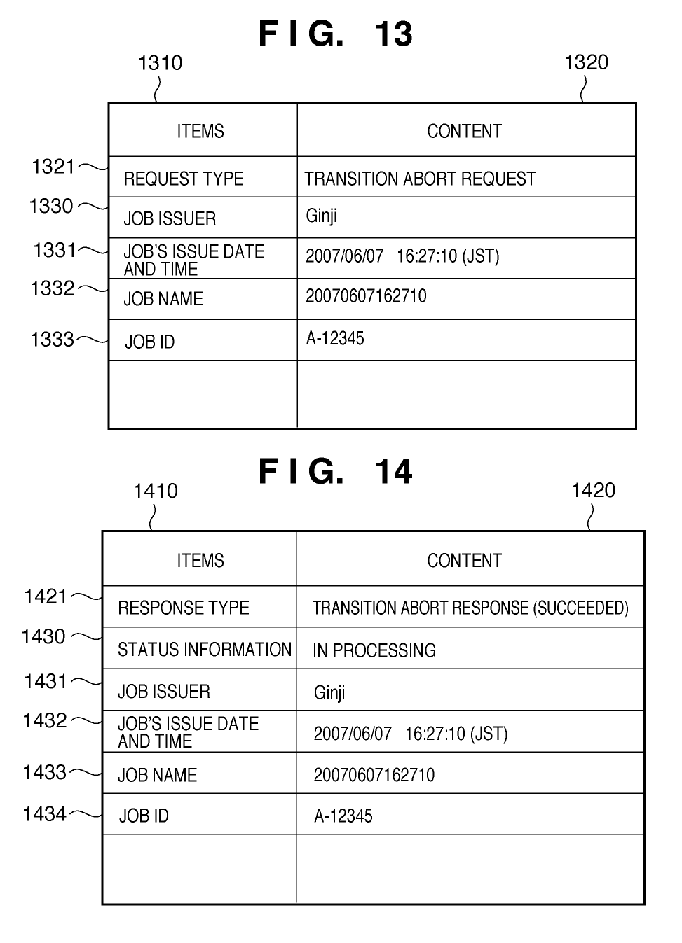

FIG. 14 shows an example of a job status change response sent in S921, S914 of FIG. 9 (information 1400). A column 1410 shows the items of information included in the job status change response, and a column 1420 shows the content of the information. A line 1421 shows the type of job status change response, and the content thereof indicates that it is a transition abort response (succeeded). A line 1431 indicates that the issuer is “Ginji”. A line 1432 indicates that the issue date and time is 16:27:10 on Jun. 7, 2007 (Japan time). A line 1433 indicates that the job name is 20070607162710. A line 1434 indicates that the job ID is A-12345.

It is to be understood that the items of the job status change response and the content thereof are merely exemplary.

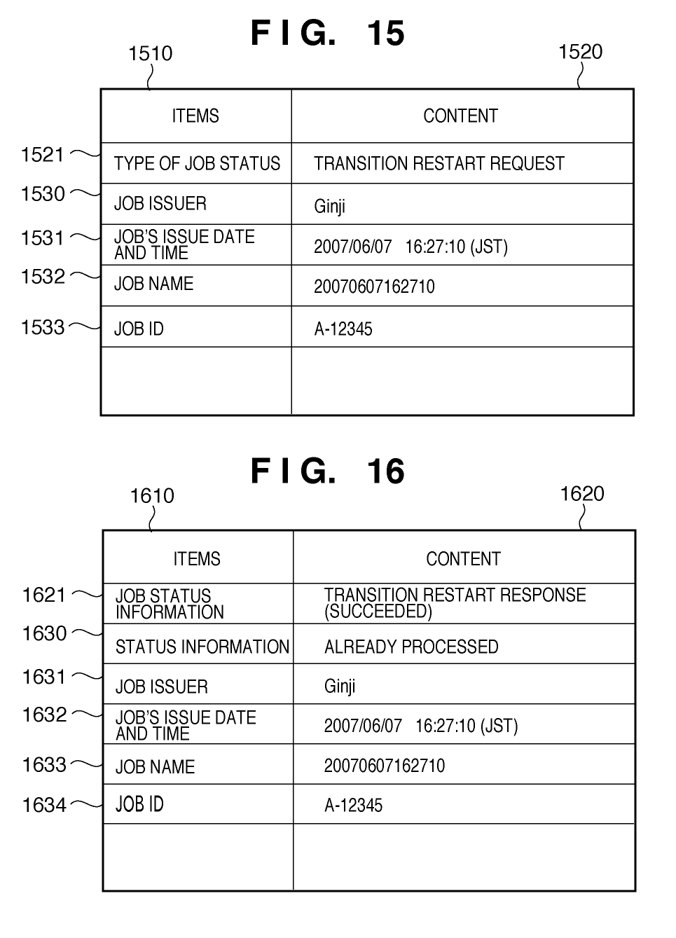

FIG. 15 shows an example of a job status change request sent in S951 of FIG. 9. A column 1510 shows the items of information included in the job status change request, and a column 1520 shows the content of the information. A line 1521 shows the type of job status change request, and the content thereof indicates that the request is to restart transition. A line 1530 indicates that the issuer is “Ginji”. A line 1531 indicates that the issue date and time is 16:27:10 on Jun. 7, 2007 (Japan time). A line 1532 indicates that the job name is 20070607162710. A line 1533 indicates that the job ID is A-12345.

It is to be understood that the items of the job status change request and the content thereof are merely exemplary.

FIG. 16 shows an example of a job status change response sent in S952 of FIG. 9. A column 1610 shows the items of information included in the job status change response, and a column 1620 shows the content of the information. A line 1621 shows the type of job status change response, and the content thereof indicates that it is a transition restart response (succeeded). A line 1631 indicates that the issuer is “Ginji”. A line 1632 indicates that the issue date and time is 16:27:10 on Jun. 7, 2007 (Japan time). A line 1633 indicates that the job name is 20070607162710. A line 1634 indicates that the job ID is A-12345.

It is to be understood that the items of the job status change response and the content thereof are merely exemplary.

In an image processing system in which a plurality of devices connected with a network or another communication means process a single job in cooperation with each other, it becomes possible to change a cooperative device from any of the devices involved in the cooperation, while they are processing the job in cooperation.

### Other Embodiments

An embodiment of the present invention has been described in detail above, but the present invention may be applied to a system configured of a plurality of devices or an apparatus configured of a single device. Although the above described embodiment was presented in the context of an example in which the image processing apparatuses are MFPs, it is possible to use various image processing apparatuses including single-function printers, scanners and so on. Also, the image processing apparatuses are not limited to apparatuses that receive and process image data, and it is also possible to use finishing apparatuses that staple or bind paper sheets printed by other apparatuses. If, for example, a scanner is used as the first cooperative device, a printer as the second cooperative device, and a finishing apparatus as the third cooperative device, these apparatuses are connected with a network, and an announcement notice is sent from the scanner as the first apparatus to the printer and the finishing apparatus in the manner described above. Image data read from an original image by the scanner is sent to the printer via the network, and the printer prints out an image onto paper based on the received image data. Then, the user loads the printed paper into the finishing apparatus, and invokes the job ID corresponding to the announcement notice from an operation unit of the finishing apparatus to perform a finishing process. With this configuration, even when part of such processing is implemented without involving a network, it becomes possible to check job status and perform operations on a job. In addition, it is possible to change a cooperative apparatus in a similar process.

It should be noted that the present invention can also be achieved by directly or remotely supplying a program that implements the functions of the above-described embodiment to a system or apparatus, and then having the system or apparatus read and execute the supplied program code. Accordingly, the computer code itself installed on a computer to implement the functional process of the present invention with a computer is also included in the scope of the present invention.

In this case, the program can take any form such as object code, a program executed by an interpreter or script data supplied to an OS, etc as long as the program has the functions of the program.

Recording media for supplying the program include, for example, a floppy® disk, a hard disk, an optical disk, and a magneto-optical disk. Other possibilities include MO, CD-ROM, CD-R, CD-RW, magnetic tape, non-volatile memory card, ROM, DVD (DVD-ROM, DVD-R), and so on.

In addition, it is also possible to employ a method in which a connection is made to an Internet website using a browser of a client PC, and then the program of the invention or a file that further includes an automatic installation function is downloaded onto a recording medium such as a hard disk. It is also possible to implement the invention by dividing up the program code constituting the program of the present invention into a plurality of files and then downloading each of the files from different websites. In other words, a WWW server that allows the program for implementing the functional process of the present invention on a computer to be downloaded by a plurality of users also falls within the scope of the invention. It is also possible to encrypt the program of the present invention, store it on a storage medium such as a CD-ROM, and distribute it to users. It is also possible to allow users that have satisfied predetermined conditions to download key information that decodes the encryption from a website through the Internet, and then through the user using that key information, to execute the encrypted program and install it on a computer.

In addition, an OS or the like running on a computer performs part or all of the actual processing based on the instructions of the program, and the functions of the above-described embodiment may also be implemented through this processing.

Furthermore, the case where the program of the present invention is written into a memory provided in a function expansion unit of a PC and part or all of the actual processing is performed by a CPU or the like provided in the function expansion unit based on the program is also included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-146220, filed on Jun. 3, 2008, which is hereby incorporated by reference herein in its entirety.

What is claimed is:

1. A job processing method for executing a job by causing a plurality of image processing apparatuses to work in cooperation with each other, the method comprising:
sending an announcement notice informing that the job will be sent from an image processing apparatus that issues a job to an image processing apparatus designated to process the job in cooperation; and
instructing the image processing apparatus that issued the job or the image processing apparatus designated to work in cooperation to abort transition of the job based on the announcement notice when excluding the image processing apparatus designated to work in cooperation from cooperation.

2. The job processing method according to claim 1, further comprising, when there is a change in the image processing apparatus designated to work in cooperation, creating an announcement notice again that includes information regarding a post-change cooperative image processing apparatus, and sending the created announcement notice to another image processing apparatus as a cooperative device.

3. The job processing method according to claim 1, further comprising:
aborting transition of the job to an image processing apparatus designated to work in cooperation in the image processing apparatus that has received the instruction in the instruction step.

4. The job processing method according to claim 1 comprising requesting the image processing apparatus that has received the instruction in the instruction step to restart transition of the job when a transition destination of the job from the image processing apparatus that has received the instruction in the instruction step is designated.

5. The job processing method according to claim 1, wherein the announcement notice step involves also sending the announcement notice to an image processing apparatus as a candidate for cooperation.

6. The job processing method according to claim 1, wherein the announcement notice includes information regarding all of the image processing apparatuses involved in the job processed in cooperation.

7. An image processing system comprising a plurality of image processing apparatuses that execute a job in cooperation with each other, wherein
an image processing apparatus that issues a job includes an announcement notice unit adapted to send an announcement notice informing that the job will be sent to an image processing apparatus designated to process the job in cooperation, and
the image processing apparatus that has received the announcement notice includes an instruction unit adapted to instruct the image processing apparatus that issued the job or the image processing apparatus designated to work in cooperation to abort transition of the job based on the announcement notice when excluding the image processing apparatus designated to work in cooperation from cooperation.

8. An image processing apparatus capable of executing a job in cooperation with another image processing apparatus, the apparatus comprising:
an announcement notice unit adapted to, when issuing a job to be executed in cooperation with another image processing apparatus, send an announcement notice informing that the job will be sent to the image processing apparatus designated to process the job in cooperation; and
an instruction unit adapted to instruct another image processing apparatus designated to work in cooperation to abort transition of the job based on the announcement notice when excluding the image processing apparatus designated to work in cooperation from cooperation after the announcement notice has been sent.

9. A recording medium storing a computer program for implementing a function of each unit of the image processing apparatus according to claim 8 through execution on a computer.
